(19) United States
(12) Patent Application Publication
(10) Pub. No.: US 2013/0021410 A1
(43) Pub. Date: Jan. 24, 2013

(54) PRINTHEAD MOUNTING SYSTEM AND METHOD THEREOF

(71) Applicants: Alon Navon, Azour Non (IL); Robert Azerrad, Netanya (IL); Ilan Weiss, Netanya (IL); Eitan Pinhasi, Netanya (IL)

(72) Inventors: Alon Navon, Azour Non (IL); Robert Azerrad, Netanya (IL); Ilan Weiss, Netanya (IL); Eitan Pinhasi, Netanya (IL)

(21) Appl. No.: 13/186,612

(22) Filed: Jul. 20, 2011

(51) Int. Cl. B41J 23/00

(52) U.S. Cl. 347/37

(57) ABSTRACT

A carriage unit useable with a printhead is provided. The carriage unit includes an alignment member and a support member. The alignment member positions the printhead and includes at least one positioning unit to engage with a fastener. The at least one positioning unit has a positioning surface and a retaining device to retain the fastener against the positioning surface. The support member is connected to the alignment member to support the printhead.

### BACKGROUND

Printheads are used in a variety of printing techniques. For example, inkjet printheads are used in computer printers and large format graphics printers. Mounting systems are used to couple one or more printheads to a carriage to facilitate printing.

### BRIEF DESCRIPTION OF THE DRAWINGS

Non-limiting examples of the present disclosure are described in the following description, read with reference to the figures attached hereto and do not limit the scope of the claims. In the figures, identical and similar structures, elements or parts thereof that appear in more than one figure are generally labeled with the same or similar references in the figures in which they appear. Dimensions of components and features illustrated in the figures are chosen primarily for convenience and clarity of presentation and are not necessarily to scale. Referring to the attached figures:

FIG. 1 illustrates a block diagram of a carriage unit according to an example;

FIG. 2A illustrates a schematic diagram of a carriage unit according to an example;

FIG. 2B illustrates an enlarged view of portion of the carriage unit of FIG. 2A;

FIG. 3 illustrates a block diagram of a mounting system according to an example;

FIG. 4 illustrates a perspective view of a mounting system according to an example;

FIG. 5 illustrates a cross-sectional view of a portion of the mounting system of FIG. 4;

FIG. 6 illustrates a schematic diagram of an array of mounting systems according to an example;

FIG. 7 illustrates a cross-sectional view of a portion of the mounting system of FIG. 6; and

FIG. 8 illustrates a flowchart of a method to mount a printhead to a carriage unit according to an example.

### DETAILED DESCRIPTION

In the following detailed description, reference is made to the accompanying drawings which form a part hereof, and in which is depicted by way of illustration specific examples in which the present disclosure may be practiced. It is to be understood that other examples may be utilized and structural or logical changes May be made without departing from the scope of the present disclosure. The following detailed description, therefore, is not to be taken in a limiting sense, and the scope of the present disclosure is defined by the appended claims.

Inkjet printheads are used in a variety of printing techniques. Individual inkjet printheads are assembled in arrays to achieve a higher print throughput and higher print resolution. The arrays may consist of, for example, one or two dimensional assemblies of printheads. Each printhead interfaces mechanically, hydraulically, and electrically with the printheads and apparatus that form the array and/or the printer. For example, the printhead mechanically interfaces with the array using a mounting that attaches the printhead to a carriage. The carriage supports the printhead and holds the printhead in place for accurate printing; however, due to the rigid nature of carriages, it is difficult to position the printheads.

In examples, a carriage unit useable with a printhead is provided. The carriage unit includes an alignment member and a support member. The alignment member positions the printhead with a positioning unit that engages with a fastener. The support member is connected to the alignment member to support the printhead. The apparatus is divided into two members to provide the rigid support and allow for accurate positioning of the printhead.

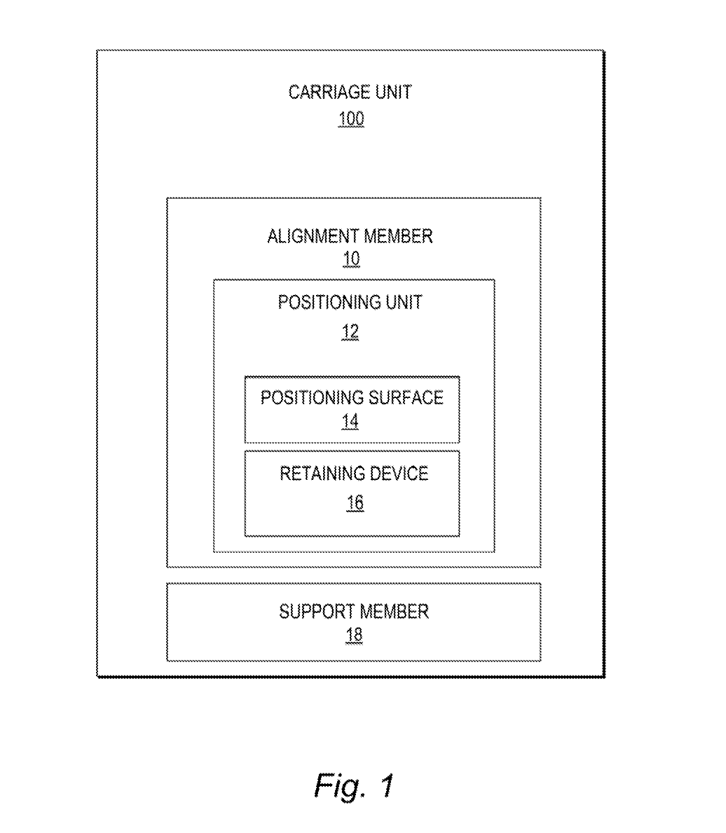

FIG. 1 illustrates a block diagram of a carriage unit 100 according to an example. The carriage unit 100 is useable with a printhead and includes an alignment member 10 and a support member 18. The alignment member 10 positions the printhead with at least one positioning unit 12 that engages with a fastener, such as a printhead fastener, which may include a fastening member, such as a locking bolt or a screw, and registration pin. The at least one positioning unit 12 has a positioning surface 14 and a retaining device 16 to retain the fastener against the positioning surface 14. The support member 18 is connected to the alignment member 10 to support the printhead.

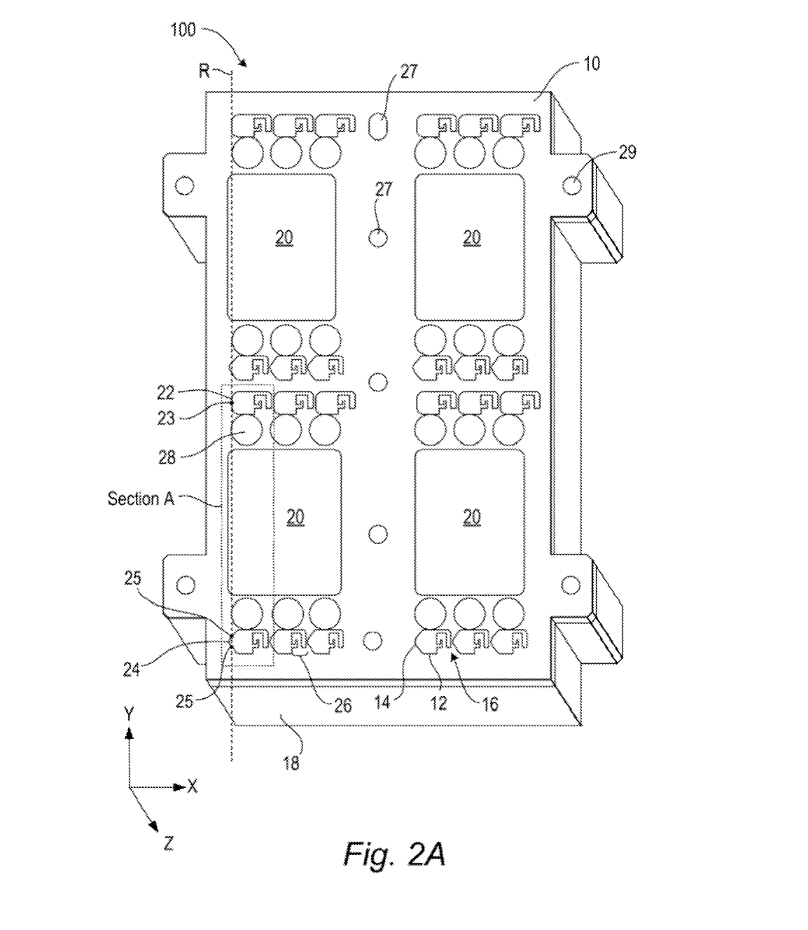

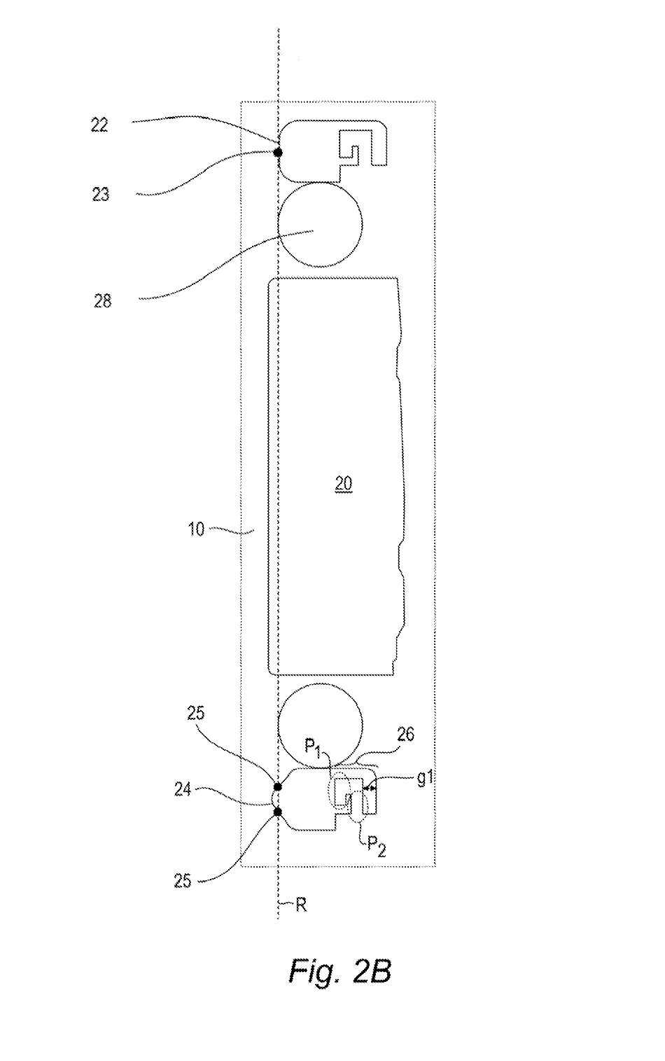

FIG. 2A illustrates a schematic diagram of a carriage unit 100 according to an example. The carriage unit 100 is illustrated with the alignment member 10 connected to the support member 18. The alignment member 10 may be a metal sheet having a thickness of approximately 0.3 millimeters and 1.0 millimeters such that the alignment member 10 has a thickness that is less than the support member 18. The alignment member 10 includes two positioning units 12 for each pririthead. The two positioning units 12 for each printhead are positioned symmetrically and aligned with one another along reference line. R.

FIG. 2B illustrates an enlarged view of a portion of the carriage unit 100 (labeled Section A of FIG. 2A) having two positioning units 12. One positioning unit 12 is located on each side of a printhead aperture 20 such that the printhead may be placed in the printhead aperture 20 and coupled to the carriage unit 100 on two opposing sides. The two positioning units 12 are illustrated with two different surfaces 14 to assist with accurate positioning of the printhead along the y-axis. For example, a linear surface 22 is on one side of the printhead aperture 20 with one contact point 23 for the fastener and a v-shaped surface 24 is on the opposite side of the printhead aperture 20 with two contact points 25 for the fastener. However, the shape of the positioning surface 14 is not limited to linear and v-shaped surfaces.

As illustrated in FIGS. 2A-2B, the v-shaped surface 24 is used on one side to position the printhead to reduce the positioning errors due to variations caused by standard production tolerances, such as the diameter of the printhead fastener that couples the printhead to the carriage unit 100. For example, two printhead fasteners with a 4 mm diameter and a 5 mm diameter both will have the same y-axis position when pressed against the v-shaped surface 24. Moreover, the linear surface 22 is used on the side opposite the v-shaped surface 24 to provide orientation around a z-axis without applying additional constraints for positioning purposes. For example, the actual distance between the linear surface 22 and the v-shaped surface 24 may be different than the actual distance between the printhead registration pins due to production tolerances.

The alignment member 10 is also illustrated with a pair of ink inlet apertures 28, one on each side of the printhead aperture 20. The ink inlet apertures 28 may receive a portion of the printhead that receives ink from a reservoir and provides a relief for the ink inlet.

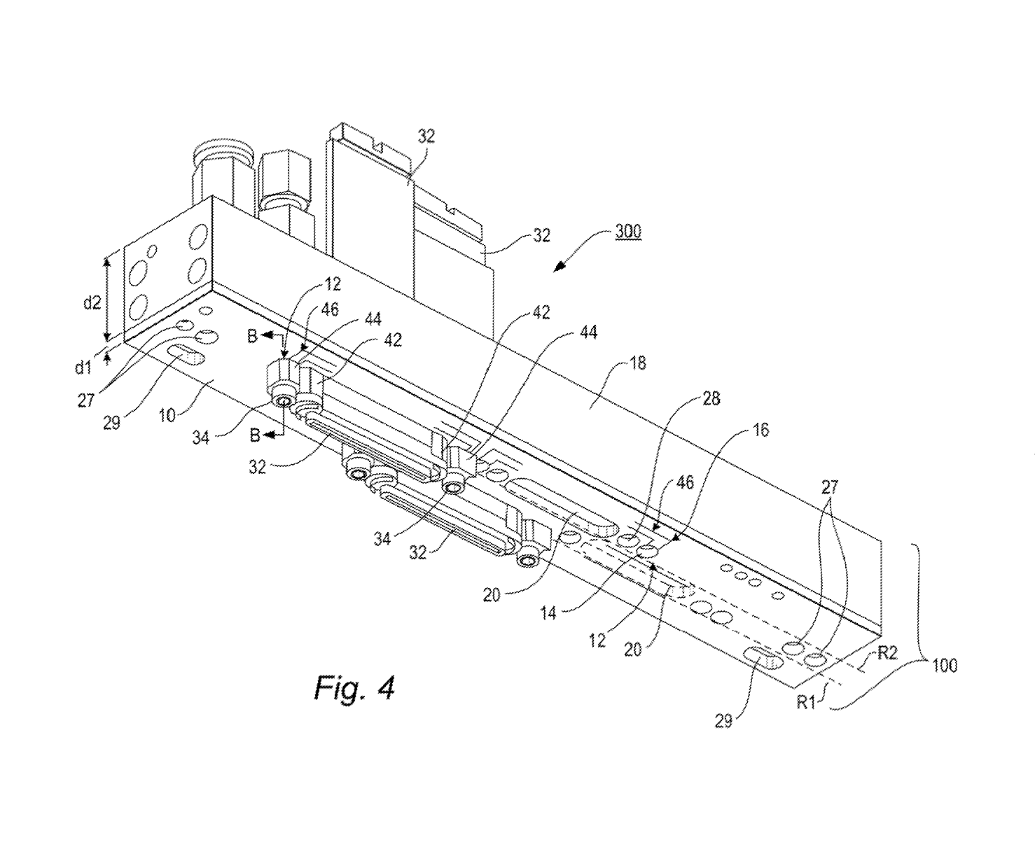

The retaining device 16 is illustrated as being formed in the alignment member 10, such as a J-shaped spring lever 26, but other retaining devices 16, such as other spring levers and/or a spring members (i.e., examples in FIGS. 4-7) may also be used. For example, the retaining device 16 may be formed from the metal sheet that forms the alignment member 10 using processes, such as chemical etching and/or electro erosion both of which remove a portion of the alignment member 10 to form the retaining device 16. The retaining device 16 has a pivot point, p1 that moves from an initial position to an engagement position. In the initial position, there is a gap with a distance g1 is between the J-shaped spring lever 26 and the alignment member 10. In an engagement position, the gap, g1, is decreased due to the movement of the spring lever 26 around the pivot point, p1. The retaining device 16 may further includes a spring point, p2 that moves from an initial state to an engagement state towards the pivot point, p1; however, the spring point, p2, typically moves a smaller distance relative to the movement of the pivot point, p1.

The carriage unit 100 may further include at least one registration aperture 27 and/or at least one fastening aperture 29 on the alignment member 10 that may be received by the support member 18. The registration aperture 27 may provide proper positioning between the alignment member 10 and the support member 18, and the fastening apertures 29 may provide a secure connection between the alignment member 10 and the support member 18. Both the registration aperture 27 and the fastening aperture 29 may be configured to receive a fastener, such as a screw or a locking bolt, to affix the alignment member 10 to the support member 18. Moreover, the carriage unit 100 is connectable to another carriage unit 100 to form an array of carriage units 100. Various fasteners and fastening technologies may be utilized with the registration aperture 27 and fastening aperture 29.

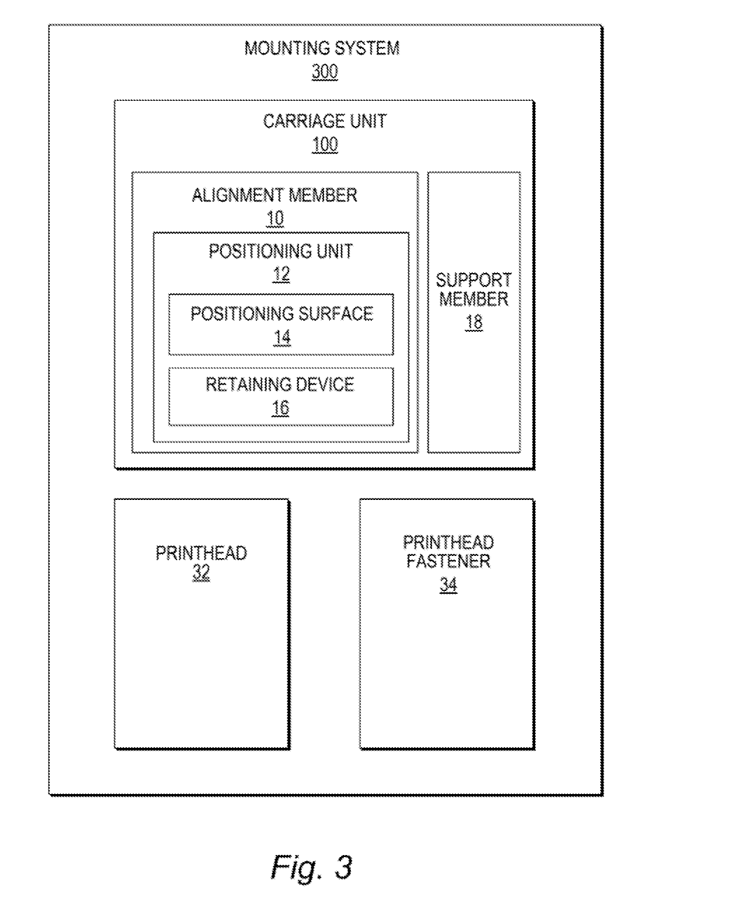

FIG. 3 illustrates a block diagram of a mounting system 300 according to an example. The mounting system 300 is useable with an image forming apparatus, for example, an inkjet printer. The mounting system 300 includes a printhead 32; a carriage unit 100, and a printhead fastener 34. The printhead 32 may include various types of printheads, such as inkjet printheads.

The carriage unit 100 includes an alignment member 10 and a support member 18, both to receive the printhead 32. The alignment member 10 positions the printhead 32 using at least one positioning unit 12 to engage with a printhead fastener 34. The at least one positioning unit 12 has a positioning surface 14 to align the printhead fastener 34 and a retaining device 16 to retain the printhead fastener 34 against the positioning surface 14. The support member 18 is connected to the alignment member 10 to support the printhead 32. The printhead fastener 34 engages with the alignment member 10 and the support member 18 to couple the printhead 32 thereto. The printhead fastener 34 may include various fasteners, such as a locking bolt and/or a screw. Moreover, the printhead fastener 34 may include a fastening member and a registration pin to cooperatively form the printhead fastener 34.

FIG. 4 illustrates a perspective view of a mounting system 300 according to an example. The mounting system 300 includes the carriage unit 100 with the alignment member 10 connected to the support member 18 and the printhead 32 coupled to the carriage unit 100 with a printhead fastener 34. As illustrated in FIG. 4, the printhead 32 is inserted through the printhead aperture 20 with an ink inlet 42 of the printhead 32 inserted into the ink inlet aperture 28. The ink inlet 42 has a fastener receiving member 44 extending therefrom to receive the printhead fastener 34, which couples the printhead 32 to the carriage unit 100. The carriage unit 100 is illustrated with two opposing ink inlet apertures 28 per printhead 32 that are positioned symmetrically and aligned with respect to one another. As illustrated in FIG. 4, the printhead and ink inlet apertures 20, 28 are aligned in two rows with the printhead apertures 20 being offset from one another. The offset configuration provides a higher print resolution, which may improve the quality of the printing.

A positioning unit 12 is located next to each of the ink inlet apertures 28. The positioning unit 12 is illustrated as a positioning surface 14 and a retaining device 16. The positioning surface 14 may be, for example, aligned along a reference line, such as reference lines R1 and R2 since there are two rows of printheads 32 illustrated in the example. The positioning surface 14 on each side of the printhead 32 may include one side having a linear surface 22 and the opposite side having a v-shaped surface 24. The retaining device 16 may hold each printhead fasteners 34 against the respective positioning surface 14 to position the printhead 32 accurately in the carriage unit 100. The retaining device 16 is illustrated as an L-shaped spring lever 46 formed from the metal sheet that form the alignment member using a process, such as chemical etching and/or electro erosion both of which remove a portion of the alignment member 10 to form the retaining device 16. The L-shaped spring lever 46 includes two L-shaped lines cut from the alignment member 10, such that the cut out portions may move slightly to retain the printhead fastener 34 in place.

The difference between the L-shaped spring lever 46 of FIG. 4 and the J-shaped spring lever 26 of FIG. 2A is that the amount of force that the spring lever applies to the registration pin and possibly the range of movement of the spring lever. For example, the force, F, represents a force/load; K is the spring constant value; and X is a compression value. The equation for force is F=K*X. The spring levers illustrated herein may obtain the same load for different spring constants by changing the compression values. For example, a force of 10 Newtons may be obtained by the L-shaped spring lever 46 with a spring constant (K) of 200 KN/m and a compression (X) of 50 μm, while the J-shaped spring lever 26 may also have a force of 10 Newtons with a spring constant (K) of 100 KN/m and a compression value (X) of 100 μm (or 0.1 mm).

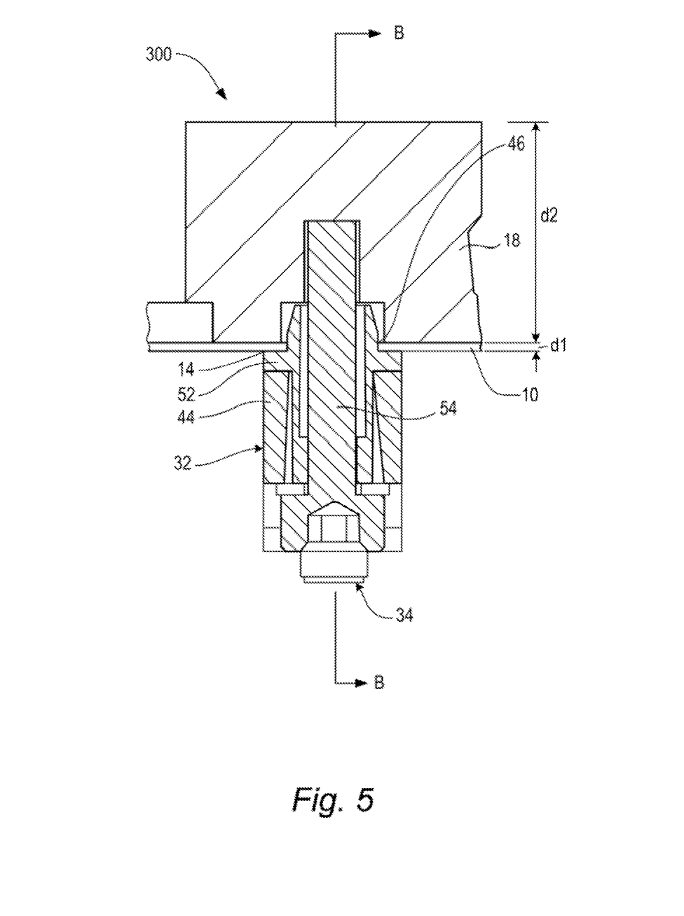

FIG. 5 illustrates a cross-sectional view of section B of the mounting system 300 of FIG. 4. In the cross-sectional view, the carriage unit 100 is illustrated with the alignment member 10 that has a thickness, d1, which is less than the thickness of the support member 18 that has a thickness of, d2. The mounting system 300 further includes a registration pin 52 that is inserted into the carriage unit 100. The registration pin 52 may form the printhead fastener 34 with a fastening member 54, such as a locking bolt. The registration pin 52 may be for example, a circular shape with a conical body that may be inserted through the alignment member 10 and into the support member 18. The fastening member 54 may be inserted into the registration pin 52, such that the printhead fastener 34 also goes through the alignment member 10 and into the support member 18. The fastening member 54 is illustrated as extending beyond the registration pin 52 into the support member 18. The printhead fastener 34 may refer to a single fastening member 54 and/or the fastening member 54 and the registration pin 52 used in combination to couple the printhead 32 to the carriage unit 100. In FIG. 5, the registration pin 52 engages with the positioning surface 14 and is retained by the L-shaped spring lever 46, such that the fastening member 54 may be inserted through the registration pin 52 to hold the registration pin 52 in place and to fasten or couple the printhead 32 to the carriage unit 100.

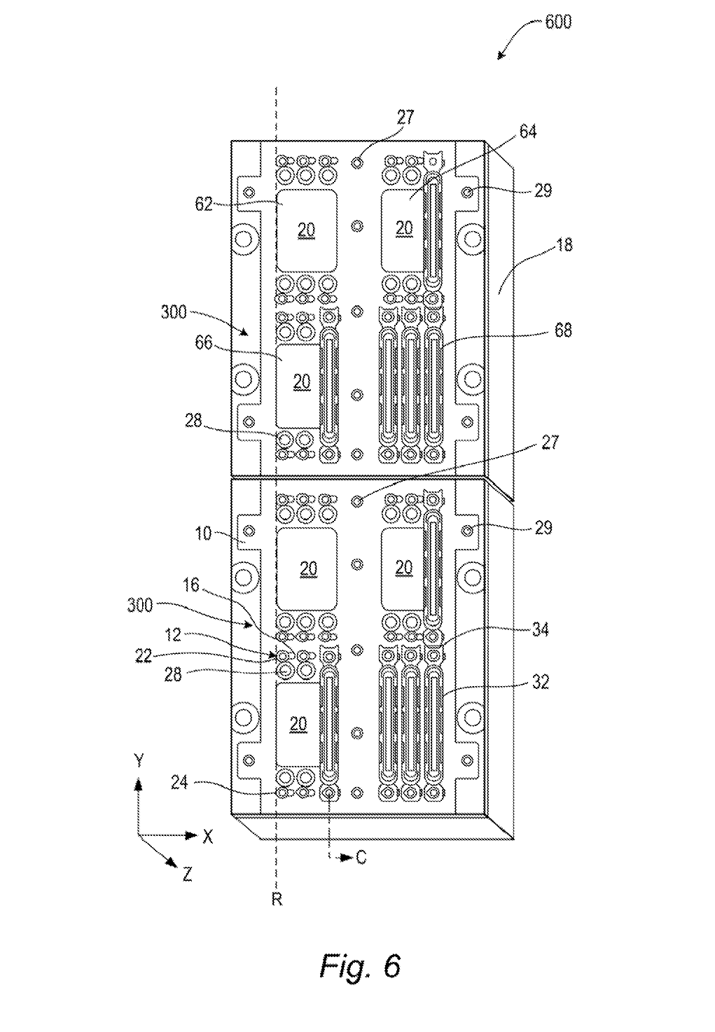

FIG. 6 illustrates a schematic diagram of an array 600 of mounting systems 300 according to an example. The mounting system 300 includes two mounting systems 300 connected to one another to form an array 600. The array 600 may be used for example in commercial printing where the printheads 32 extend across a larger area than a typical sheet of paper, such as a standard letter sheet that is 8½ inches by 11 inches. The mounting systems 300 illustrated in FIG. 6 includes a carriage unit 100, a plurality of printheads 32, and a printhead fastener 34. The carriage unit 100 includes an alignment member 10 and a support member 18. The alignment member 10 includes printhead apertures 20 to receive printheads 32, positioning units 12 for each printhead, and ink inlet apertures 28 for each printhead 32.

Four printhead apertures 20 for each carriage unit 100 are illustrated in FIG. 6. The printhead apertures 20 may each receive one or more printheads 32, and are illustrated as being capable of receiving three printheads 12 each. The alignment member 10 includes two printhead positioning units 12 and two ink inlet apertures 28 per printhead 32. The two positioning units 12 may be used to position and align each printhead 32 symmetrically. Each alignment member 10 further includes five registration apertures 27 and four fastening apertures 29; however the number and arrangement of the positioning units 12, printhead apertures 20, ink inlet apertures 28, registration apertures 27, and fastening apertures 29 may vary depending on the printhead 32 and/or image forming apparatus.

The carriage unit 100 may be arranged so that a plurality of printheads 32 are inserted into each printhead aperture 20. For example, when there are a plurality of printheads 32 in the carriage unit 100, the printheads 32 may be aligned with one another in various arrangements. For example, each printhead aperture 20 may receive a plurality of printheads 32 each printhead 32 in the printhead aperture 20 having the same color, such that a first printhead aperture 20 may include three black printheads 62, a second printhead aperture 20 may include three cyan printheads 64, a third printhead aperture 20 may include three magenta printheads 66, and a fourth printhead aperture 20 may include three yellow printheads 68. Such an arrangement may provide high print resolution since there are multiple printheads 32 for each color.

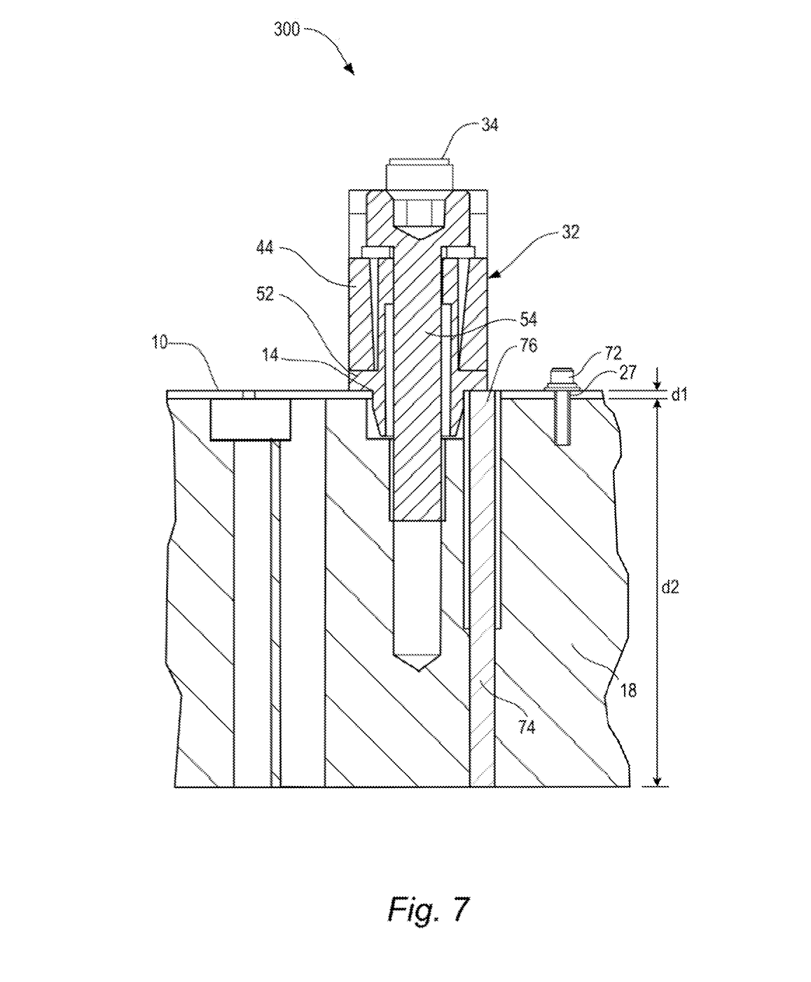

FIG. 7 illustrates a cross-sectional view of section C of the mounting system of FIG. 6. Section C illustrates a cross-sectional view of the carriage unit 100 with the alignment member 10 having a thickness d1 that is less than the thickness d2 of the support member 18. A registration pin 52 may be inserted into the positioning unit 12. The registration pin 52 may have a cylindrical outer diameter that is a conically shaped, such that the registration pin 52 may be inserted through the alignment member 10 and into the support member 18. A fastening member 54 may then be inserted into the registration pin 52. The registration pin 52 may receive pressure from the positioning unit 12 to hold the printhead 10 in aligned position. The cross sectional view also illustrates a registration fastener 72 inserted into the registration aperture 27 of the alignment member 10 to fasten the alignment member 10 and the support member 18 together.

Referring to FIGS. 6-7, the positioning unit 12 includes a positioning surface 14 and a retaining device 16 that includes a spring 74 that works with the printhead fastener 34 to form a spring member 76 to apply pressure to the printhead fastener 34 to retain the printhead fastener 34 against the positioning surface 14. The positioning surface 14 of at least one of the positioning unit 12 may be v-shaped 24, such that the printhead fastener 34 contacts the positioning surface 14 at the two points 25 of the v-shaped surface 24 to hold the printhead 32 in place for accurate alignment of the printhead 32 on the alignment member 10. For example, when there are two positioning units 12 for each printhead 32, one positioning unit 12 may include a v-shaped surface 24, while the other positioning unit 12 may include a linear surface 22 with one point 23, as illustrated in FIGS. 2A-2B. However, no matter what the shape of the positioning surface 14, the positioning surface 14 may be used to align multiple printheads 32, for example in a series, along a reference line, R. As discussed above, the retaining device 16 may further include other retaining mechanisms, such as spring levers 24, 26.

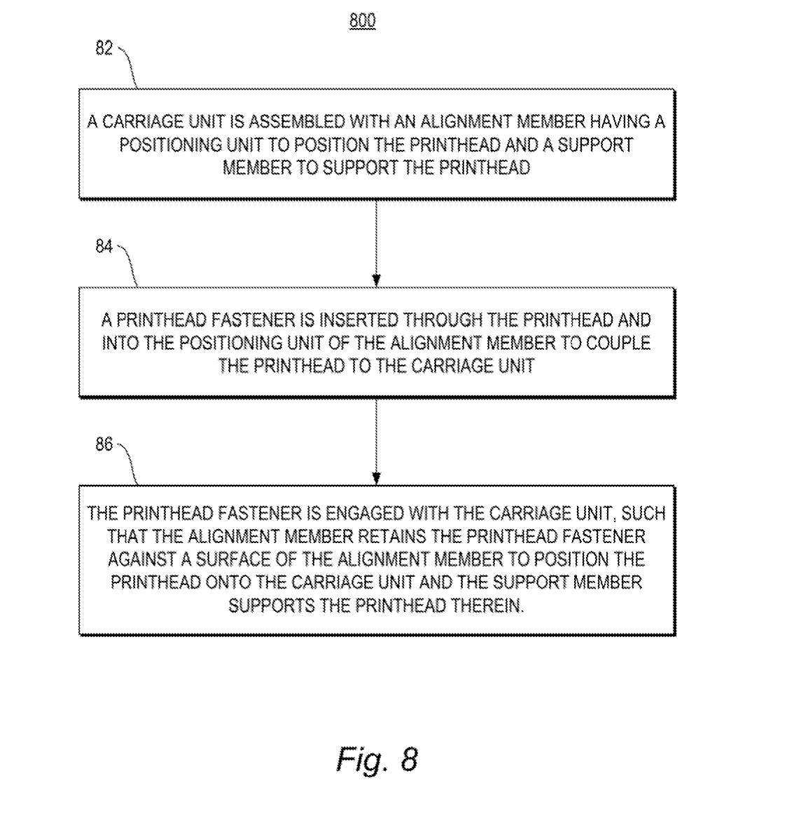

FIG. 8 illustrates a flowchart of a method to mount a printhead to a carriage unit according to an example. In block 82, the carriage unit is assembled from two connectable members including an alignment member and a support member. The alignment member has a positioning unit to position the printhead. The support member is connected to the alignment member and supports the printhead therein. A printhead fastener is inserted through the printhead and into the positioning unit of the alignment member to couple the printhead to the carriage unit, in block 84. The printhead fastener may include, for example, a printhead registration pin and a fastening member insertable into the printhead registration pin. In block 86, the printhead fastener engages with the carriage unit, such that the alignment member retains the printhead fastener against a surface of the alignment member. For example, inserting a spring member into one portion of the positioning unit and a registration pin into an adjacent portion of the positioning unit, such that the spring member applies pressure to the registration pin. The printhead is positioned onto the carriage unit and the support member supports the printhead therein.

A support registration pin and a support screw may be inserted through the alignment member and through the support member to secure the alignment member and the support member to one another, to assemble the carriage unit. The carriage unit may also be connected to one or more additional carriage units to form an array of carriage units, as illustrated in FIG. 6.

The present disclosure has been described using non-limiting detailed descriptions of examples thereof and is not intended to limit the scope of the present disclosure. It should be understood that features and/or operations described with respect to one example may be used with other examples and that not all examples of the present disclosure have all of the features and/or operations illustrated in a particular figure or described with respect to one of the examples. Variations of examples described will occur to persons of the art. Furthermore, the terms “comprise,” “include,” “have” and their conjugates, shall mean, when used in the present disclosure and/or claims, “including but not necessarily limited to.”

It is noted that some of the above described examples may include structure, acts or details of structures and acts that may not be essential to the present disclosure and are intended to be exemplary. Structure and acts described herein are replaceable by equivalents, which perform the same function, even if the structure or acts are different, as known in the art. Therefore, the scope of the present disclosure is limited only by the elements and limitations as used in the claims.

What is claimed is:

1. A carriage unit useable with a printhead, the carriage unit comprising:
an alignment member to position the printhead, the alignment member including:
at least one positioning unit to engage with a fastener, the at least one positioning unit having a positioning surface and a retaining device to retain the fastener against the positioning surface; and
a support member connected to the alignment member to support the printhead.

2. The carriage unit of claim 1, wherein the retaining device is a spring lever.

3. The carriage unit of claim 1, wherein the retaining device is a spring member.

4. The carriage unit of claim 1, wherein the at least one positioning unit includes two positioning units for each printhead that are symmetrically positioned and aligned with one another.

5. The carriage unit of claim 4, wherein the positioning surface of at least one of the positioning units is v-shaped.

6. The carriage unit of claim 4, wherein the positioning surface of at least one of the position units is linear.

7. The carriage unit of claim 1, wherein the alignment member has a thickness between 0.3 millimeters and 1.0 millimeters.

8. The carriage unit of claim 1, wherein the carriage unit is connectable to another carriage unit to form an array of carriage units.

9. The carriage unit of claim 1, further comprising a carriage fastener to affix the alignment member to the support member.

10. A mounting system useable with an image forming apparatus, the mounting system comprising:
a printhead;
a carriage unit to receive the printhead, the carriage unit including:
an alignment member to position the printhead, the alignment member including:
at least one positioning unit to engage with a printhead fastener, the at least one positioning unit having a positioning surface to align the printhead fastener and a retaining device to retain the printhead fastener against the positioning surface; and
a support member connected to the alignment member to support the printhead, wherein the printhead fastener engages with the alignment member and the support member to couple the printhead thereto; and
the printhead fastener to couple the printhead to the carriage unit.

11. The mounting system of claim 10, wherein the retaining device is a spring lever.

12. The mounting system of claim 10, wherein the retaining device is a spring member.

13. The mounting system of claim 10 wherein the at least one positioning unit includes two positioning units for each printhead that are symmetrically positioned and aligned with one another.

14. The mounting system of claim 13, wherein the positioning surface of at least one of the positioning units is v-shaped.

15. The mounting system of claim 10, further comprising a printhead registration pin insertable into the alignment member to receive the printhead fastener, wherein the printhead registration pin receives pressure from the retaining device to hold the printhead in place.

16. The mounting system of claim 10, wherein the carriage unit includes a plurality of printhead apertures, each printhead aperture to receive at least one printhead.

17. A method to mount a printhead to a carriage unit, the method comprising:
assembling the carriage unit, the carriage unit having two connectable members, the connectable members include an alignment member with a positioning unit to position the printhead and a support member to support the printhead;
inserting a printhead fastener through the printhead and into the positioning unit of the alignment member to couple the printhead to the carriage unit; and
engaging the printhead fastener with the carriage unit, such that the alignment member retains the printhead fastener against a positioning surface of the alignment member to position the printhead onto the carriage unit and the support member supports the printhead therein.

18. The method of claim 17, further comprising inserting a spring member into one portion of the positioning unit and a registration pin into an adjacent portion of the position unit, such that the spring member applies pressure to the registration pin.

19. The method of claim 17, wherein assembling the carriage unit includes:
inserting at least one support registration pin into at least one alignment member registration aperture; and
securing the carriage unit to the support member using at least one screw.

20. The method of claim 17, further comprising connecting the carriage unit to one or more additional carriage units to form an array of carriage units.
